(19) United States
(12) Patent Application Publication
(10) Pub. No.: US 2022/0018004 A1
(43) Pub. Date: Jan. 20, 2022

(54) NON-ORIENTED ELECTRICAL STEEL SHEET AND METHOD FOR MANUFACTURING SAME

(71) Applicant: POSCO, Pohang-si, Gyeongsangbuk-do (KR)

(72) Inventors: Hun Ju LEE, Pohang-si, Gyeongsangbuk-do (KR); Su-Yong SHIN, Pohang-si, Gyeongsangbuk-do (KR); Yong-Soo KIM, Pohang-si, Gyeongsangbuk-do (KR)

(21) Appl. No.: 17/298,128

(22) PCT Filed: Nov. 27, 2019
(86) PCT No.: PCT/KR2019/016492

§ 371 Date: May 28, 2021

(30) Foreign Application Priority Data
Nov. 30, 2018 (KR) 10-2018-0153084

(51) Int. Cl. C22C 38/16; C22C 38/02; C22C 38/06; C22C 38/04; C22C 38/00; C21D 9/46; C21D 8/02

(52) U.S. Cl. CPC C22C 38/16; C22C 38/02; C22C 38/06; C22C 38/04; C21D 8/0236; C21D 9/46; C21D 8/0205; C21D 8/0226; C22C 38/002

(57) ABSTRACT

A non-oriented electrical steel sheet according to one embodiment of the present invention comprises, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfies formulas 1 and 2 below.

150≤[Mn]/[Cu]≤250 [Formula 1]

3≤[Cu]/[S]≤7 [Formula 2]

(here, [Mn], [Cu], and [S] represent Mn, Cu, and S contents (weight %), respectively.)

### TECHNICAL FIELD

The present invention relates to a non-oriented electrical steel sheet and a method for manufacturing the same. Particularly, the present invention relates to a non-oriented electrical steel sheet and a method for manufacturing the same, which improve magnetic properties by controlling a distribution of the sulfide by appropriately controlling a relationship between Mn, Cu, and S.

### BACKGROUND ART

A non-oriented electrical steel sheet is mainly used for a motor that converts electrical energy into mechanical energy, and in the meantime, excellent magnetic characteristics of the non-oriented electrical steel sheet are required to show high efficiency. In particular, in recent years, it is considered to be very important to increase efficiency of the motor which occupies a majority of total electrical energy consumption while eco-friendly technology is attracting attention, and to this end, a demand for the non-oriented electrical steel sheet having the excellent magnetic characteristics has also increased.

The magnetic characteristics of the non-oriented electrical steel sheet are mainly evaluated by iron loss and magnetic flux density. The iron loss means energy loss generated at a specific magnetic flux density and a specific frequency, and the magnetic flux density means a degree of magnetic properties obtained under a specific magnetic field. The lower the iron loss, a motor having high energy efficiency can be manufactured under the same condition, and the higher the magnetic flux density, the motor can be miniaturized and copper loss can be reduced, and as a result, it is important to manufacture a non-oriented electrical steel sheet having low iron loss and high magnetic flux density.

The characteristics of the non-oriented electrical steel sheet that should be considered according to operating conditions of the motor are also different. As a criterion for evaluating the characteristics of the non-oriented electrical steel sheet used for the motor, W_{15/50} which is iron loss when a magnetic field of 1.5 T is applied at a commercial frequency of 50 Hz are considered to be most important in multiple motors. However, in all motors for various usages, the iron loss of W_{15/50} is not considered to be most important, and according to a main operating condition, iron loss at a different frequency or applied magnetic field may also be evaluated. In particular, in recent years, since there are many cases where the magnetic characteristics are important at 1.0 T or a low magnetic field of 1.0 T or less, and a high frequency of 400 Hz or more in a non-oriented electrical steel sheet having a thickness of 0.35 mm or less used for a driving motor of an electrical vehicle, the characteristics of the non-oriented electrical steel sheet are evaluated by the iron loss such as W_{10/400}, etc.

A method generally used to increase the magnetic characteristics of the non-oriented electrical steel sheet is to add an alloy element such as Si, etc. The addition of the alloy element may increase the resistivity of steel and as the resistivity increases, eddy current loss decreases, thereby reducing total iron loss. On the contrary, there is a disadvantage in that as a Si addition amount increases, the magnetic flux density is lowered and brittleness increases, and when Si is added with a predetermined amount or more, cold rolling is impossible, so that commercial production becomes impossible. In particular, as a thickness of the electrical steel sheet is made to decrease, there may be an effect that the iron loss is reduced, and reduction in rolling property by the brittleness becomes a critical problem. Meanwhile, in addition to Si, there is an attempt to add an element such as Al, Mn, etc., in order to increase the resistivity of additional steel.

In particular, since the addition of Mn can minimize the increase in brittleness of the steel and increase the resistivity, the addition of Mn is actively used for a method for manufacturing a non-oriented electrical steel sheet for a high frequency, in which the resistivity is considered to be important. However, as an additional amount of Mn increases, Mn is coupled to sulfur which is easily chemically coupled to Mn to form sulfide or impurities contained in alloy iron form a precipitate, degrading the magnetic properties. For this reason, enhancement of the iron loss of the steel through Mn addition requires a very difficult manufacturing technology.

### DISCLOSURE

### Technical Problem

The present invention has been made in an effort to provide a non-oriented electrical steel sheet and a method for manufacturing the same. More particularly, the present invention has been made in an effort to provide a non-oriented electrical steel sheet and a method for manufacturing the same, which improve magnetic properties by controlling a distribution of the sulfide by appropriately controlling a relationship between Mn, Cu, and S.

### Technical Solution

An exemplary embodiment of the present invention provides a non-oriented electrical steel sheet comprising, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfying formulas 1 and 2 below.

150≤[Mn]/[Cu]≤250 [Formula 1]

3≤[Cu]/[S]≤7 [Formula 2]

(here, [Mn], [Cu], and [S] represent Mn, Cu, and S contents (weight %), respectively.)

The non-oriented electrical steel sheet may further comprise at most 0.005 weight % of each of at least one of C and N.

The non-oriented electrical steel sheet may further comprise at most 0.004 weight % of each of at least one of Nb, Ti, and V.

The non-oriented electrical steel sheet may further comprise at least one of at most 0.02% of P, at most 0.002% of B, at most 0.005% of Mg, and at most 0.005% of Zr.

The number of sulfides having a diameter of 150 to 300 nm may be twice or more larger than the number of sulfides having a diameter of 20 to 100 nm.

The non-oriented electrical steel sheet may comprise sulfides having the diameter of 150 to 300 nm, wherein an area fraction of sulfides containing both Mn and Cu among the sulfides having the diameter of 150 to 300 nm may be 70% or more.

A thickness of a steel sheet may be 0.1 to 0.3 mm.

An average grain diameter may be 40 to 100 μm.

Another exemplary embodiment of the present invention provides a method for manufacturing a non-oriented electrical steel sheet which comprises, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfies formulas 1 and 2 below, comprising: heating a slab satisfying formulas 1 and 2 below; preparing a hot rolling sheet by hot-rolling the slab; preparing a cold rolling sheet by cold-rolling the hot rolling sheet; and finally annealing the cold rolling sheet.

150≤[Mn]/[Cu]≤250 [Formula 1]

3≤[Cu]/[S]≤7 [Formula 2]

(here, [Mn], [Cu], and [S] represent Mn, Cu, and S contents (weight %), respectively.)

In the heating of the slab, the slab may be heated at a temperature of 1200° C. or less.

In the hot rolling, a finishing rolling temperature may be 750° C. or more.

The method for manufacturing a non-oriented electrical steel sheet may further comprise annealing the hot rolling sheet in the range of 850 to 1150° C., after the hot rolling.

The cold rolling may include one cold rolling or two or more cold rolling with intermediate annealing interposed therebetween.

The intermediate annealing temperature may be 850 to 1150° C.

According to an exemplary embodiment of the present invention, by presenting an optimum alloy composition of a non-oriented electrical steel sheet, an appropriate sulfide-based precipitate is formed, thereby manufacturing a non-oriented electrical steel sheet having excellent magnetic properties.

Further, according to an exemplary embodiment of the present invention, it is possible to contribute to enhancement of efficiency of a motor and a generator through a non-oriented electrical steel sheet having excellent magnetic properties.

### DESCRIPTION OF THE DRAWINGS

FIGS. 1 to 4 are photographs of an electron microscope of sulfide containing both Mn and Cu.

### MODE FOR INVENTION

Terms including first, second, and third are used for describing various arts, components, regions, layers, and/or sections, but are not limited thereto. The terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present invention.

Special terms used herein is for the purpose of describing specific exemplary embodiments only and are not intended to be limiting of the present invention. The singular forms used herein include plural forms as well, if the phrases do not clearly have the opposite meaning. The term “including” used in the specification means that a specific feature, region, integer, step, operation, element and/or component is embodied and other specific features, regions, integers, steps, operations, elements, and/or components are not excluded.

When any part of or referred to as being “on”, “over” the other part, which might be directly on or over the other parts or may be a different part involves therebetween. On the contrary, when any part is mentioned as being “directly on” the other parts, the other part is not interposed therebetween.

Further, unless particularly mentioned, % means weight % and 1 ppm is 0.0001 weight %.

In an exemplary embodiment of the present invention, further comprising an additional element means substitutingly comprising the remainder comprising Fe as much as an additional amount of the additional element.

Unless defined otherwise, all terms including technical and scientific terms used herein have the same meaning as commonly understood by those skilled in the art to which the present invention belongs. Commonly used predefined terms are further interpreted as having a meaning consistent with the relevant technical literature and the present disclosure, and are not to be construed as ideal or very formal meanings unless defined otherwise.

The present invention will be described more fully hereinafter, in which exemplary embodiments of the invention are shown. As those skilled in the art would realize, the described embodiments may be modified in various different ways, all without departing from the spirit or scope of the present invention.

A non-oriented electrical steel sheet according to one embodiment of the present invention comprises, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfies formulas 1 and 2 below.

150≤[Mn]/[Cu]≤250 [Formula 1]

3.00≤[Cu]/[S]≤7.00 [Formula 2]

(here, [Mn], [Cu], and [S] represent Mn, Cu, and S contents (weight %), respectively.)

Hereinafter, the reason for component limitation of the non-oriented electrical steel sheet will be first described.

Si: 1.5 to 4.0 wt %

Silicon (Si) is a major element to be added to lower eddy current loss among iron loss by increasing the resistivity of the steel. If Si is added too small, there is a problem in that the iron loss deteriorates. On the contrary, if Si is added too large, the magnetic flux density is greatly reduced, and as a result, there may be a problem in processibility. Therefore, Si may be included in the above-described range. More specifically, Si may be included in 2.0 to 3.9 wt %. More specifically, Si may be included in 2.5 to 3.8 wt %.

Al: 0.7 to 2.5 wt %

Aluminum (Al) is an element that plays an important role in increasing the resistivity with Si to reduce the iron loss and plays a role in reducing magnetic anisotropy to reduce magnetic deviation in a rolling direction and a rolling vertical direction. If Al is added too small, it is difficult to expect a magnetic properties improvement effect by forming fine nitrides. If Al is added too large, the nitrides are excessively formed, and as a result, the magnetic properties may deteriorate. Therefore, Al may be included in the above-described range. More specifically, Al may be included in 1.0 to 2.0 wt %.

Mn: 1.0 to 2.0 wt %

Manganese (Mn) serves to improve the iron loss and form sulfides by increasing the resistivity of a material. If Mn is added too small, the sulfides are finely formed, which may cause magnetic properties deterioration. On the contrary, if Mn is added too large, MnS is excessively precipitated and formation of {111} texture disadvantageous to the magnetic properties is promoted, and as a result, the magnetic flux density may be rapidly reduced. More specifically, Mn may be included in 0.9 to 1.9 wt %.

Cu: 0.003 to 0.020 wt %

Copper (Cu) is an element capable of forming a stable sulfide at a high temperature and an element which causes a defect on the surface when being added with a large amount. When an appropriate amount is added, there is an effect of improving the magnetic properties by increasing the size of the sulfide and decreasing a distribution density. More specifically, Cu may be included in 0.005 to 0.015 wt %.

S: 0.005 wt % or less

Since sulfur (S) forms fine precipitates MnS, CuS, and (Mn, Cu)S to deteriorate magnetic characteristics and deteriorate hot processibility, S is preferably managed to be low. More specifically, S may be included in 0.0001 to 0.005 wt %. More specifically, S may be included in 0.0005 to 0.0035 wt %.

The non-oriented electrical steel sheet according to an exemplary embodiment of the present invention may further include at most 0.005 wt % of each of at least one of C and N. More specifically, the non-oriented electrical steel sheet may further include at most 0.005 wt % of C and at most 0.005 wt % of N.

C: 0.005 wt % or less

Carbon (C) causes magnetic aging and is bounded to other impurity elements to generate a carbide, thereby deteriorating the magnetic characteristics, so that C is preferably low. When C is further included, C may be further included in 0.005 wt % or less. More specifically, C may be further included in 0.003 wt % or less.

N: 0.005 wt % or less

Nitrogen (N) forms a fine and long AlN precipitate in a base material, and is bounded to other impurities to form a fine nitride, thereby suppressing grain growth and deteriorate the iron loss. Therefore, when N is further included, N may be further included in 0.005 wt % or less. More specifically, N may be further included in 0.003 wt % or less.

The non-oriented electrical steel sheet according to an exemplary embodiment of the present invention may further include at most 0.004 weight % of each of at least one of Nb, Ti, and V. More specifically, the non-oriented electrical steel sheet further include at most 0.004 wt % of each of Nb, Ti, and V.

Niobium (Nb), titanium (Ti), and vanadium (V) are elements that are very strong in the formation of the precipitates, and suppress the grain growth by forming fine carbide, nitrides, or sulfides in the base material, thereby deteriorating the iron loss

Therefore, when at least one of Nb, Ti, and V is further included, each content may become 0.004 wt % or less. More specifically, each of Nb, Ti, and V may be included in 0.002 wt % or less.

The non-oriented electrical steel sheet according to an exemplary embodiment of the present invention may further include at least one of at most 0.02% of P, at most 0.002% of B, at most 0.005% of Mg, and at most 0.005% of Zr. More specifically, the non-oriented electrical steel sheet may further include at most 0.02% of P, at most 0.002% of B, at most 0.005% of Mg, and at most 0.005% of Zr.

The elements are very small, but may cause magnetic deterioration through formation of an inclusion in the steel, so the elements may be managed in at most 0.02% of P, at most 0.002% of B, at most 0.005% of Mg, and at most 0.005% of Zr.

The remainder includes Fe and unavoidable impurities. The unavoidable impurities are impurities that are incorporated in a steel making step and a manufacturing process of an oriented electrical steel sheet, and since the impurities are widely known in the corresponding field, a detailed description thereof will be omitted. In one embodiment of the present invention, addition of an element is not excluded in addition to the alloy component and various elements may be included within the scope without departing from the technical spirit of the present invention. When additional elements are further included, the additional elements are included by replacing the remainder Fe.

As described above, in one embodiment of the present invention, the distribution of the sulfide is controlled by appropriately controlling the relationship between Mn, Cu, and S, thereby enhancing the magnetic properties.

Specifically, the number of sulfides having a diameter of 150 to 300 nm may be twice or larger than the number of sulfides having a diameter of 20 to 100 nm. Since the sulfides having the diameter of 150 to 300 nm interfere with magnetic domain wall movement as compared with the sulfides having the diameter of 20 to 100 nm to have a small characteristic of deteriorating the magnetic characteristics, the number of sulfides having the diameter of 150 to 300 nm increases to enhance the magnetic properties. At this time, the diameter of the sulfide refers to a diameter when the sulfide is observed in a surface parallel to the rolling surface (ND surface). The diameter refers to a diameter of a circle when the circle is assumed to have the same area as the sulfide. A ratio of the number of sulfides having the diameter of 150 to 300 nm and the number of sulfides having the diameter of 20 to 100 nm is a ratio of the number when observed in an area of at least 5 μm×5 μm or more. More specifically, the number of sulfides having the diameter of 150 to 300 nm may be twice to 3.5 times larger than the number of sulfides at a diameter of 20 to 100 nm.

Specifically, the density of sulfides having the diameter of 20 to 100 nm may be 20 to 40 sulfides/mm². The density of the sulfides having the diameter of 150 to 300 nm may be 60 to 100 sulfides/mm².

An area fraction of the sulfides containing both Mn and Cu among the sulfides having the diameter of 150 to 300 nm may be 70% or more. Since the sulfides containing both Mn and Cu are large in size and small in the number per unit area as compared with the sulfides containing Mn or Cu alone, the effect of disturbing the migration of the magnetic wall and the grain growth is significantly lowered. When the area fraction of the sulfides containing both Mn and Cu is 70% or more, the effect is clearly exhibited, so that the magnetic properties of the steel sheet are improved.

The thickness of the steel sheet may be 0.1 to 0.3 mm. The average grain diameter may be 40 to 100 μm. In the case of having appropriately the thickness and the average grain diameter, the magnetic properties may be improved.

As described above, in an exemplary embodiment of the present invention, the relationship between Mn, Cu, and S is appropriately controlled to control the distribution of the sulfides, thereby improving the magnetic properties. Specifically, the iron loss W_{15/50} of the non-oriented electrical steel sheet may be 1.9 W/Kg or less, the iron loss W_{10/400} may be 9.5 W/kg or less, and the magnetic flux density B₅₀ may be 1.65 T or more. The iron loss W_{15/50} is iron loss when the magnetic flux density of 1.5 T is left at a frequency of 50 Hz. The iron loss W_{10/400} is iron loss when the magnetic flux density of 1.0 T is left at a frequency of 400 Hz. The magnetic flux density B₅₀ is a magnetic flux density induced in a magnetic field of 5000 Nm. More specifically, the iron loss W_{15/50} of the non-oriented electrical steel sheet may be 1.9 W/Kg or less, the iron loss W_{10/400} may be 9.5 W/kg or less, and the magnetic flux density B₅₀ may be 1.65 T or more.

A method for manufacturing a non-oriented electrical steel sheet according to an exemplary embodiment of the present invention includes heating a slab; preparing a hot rolled sheet by hot-rolling the slab; preparing a cold rolled sheet by cold-rolling the hot rolled sheet; and finally annealing the cold rolled sheet.

First, the slab is heated.

Alloy components of the slab have been described in the alloy components of the non-oriented electrical steel sheet described above, and thus the duplicated description will be omitted. In the process of manufacturing the non-oriented electrical steel sheet, since the alloy components are not substantially changed, the alloy components of the non-oriented electrical steel sheet and the slab are substantially the same as each other.

Specifically, the slab may comprise, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfy formulas 1 and 2 below.

150≤[Mn]/[Cu]≤250 [Formula 1]

3.00≤[Cu]/[S]≤7.00 [Formula 2]

(here, [Mn], [Cu], and [S] represent Mn, Cu, and S contents (weight %), respectively.)

Other additional elements have been described in the alloy components of the non-oriented electrical steel sheet, and thus, the duplicated description will be omitted.

The heating temperature of the slab is not limited, but the slab may be heated to 1200° C. or less. If the slab heating temperature is too high, a precipitate such as AlN, MnS, and the like present in the slab is resolublized and then finely precipitated during hot rolling and annealing to suppress the grain growth and deteriorate the magnetic properties.

Next, the slab is hot-rolled to prepare the hot rolled sheet. The thickness of the hot rolled sheet may be 2.5 mm or less. In the process of preparing the hot rolled sheet, the finish rolling temperature may be 750° C. or more. Specifically, the finish rolling temperature may be 750 to 1000° C. The hot rolled sheet may be wound at a temperature of 700° C. or less.

After the preparing of the hot rolled sheet, the method may further include annealing the hot rolled sheet. At this time, the annealing temperature of the hot rolled sheet may be 850 to 1150° C. When the annealing temperature of the hot rolled sheet is too low, the tissue is not grown or finely grown, so that it is not easy to obtain a texture favorable for the magnetic properties during annealing after cold rolling. When the annealing temperature is too high, the magnetic grain is excessively grown and the surface defects of the sheet are excessive. The annealing of the hot rolled sheet is performed to increase an orientation favorable for the magnetic properties if necessary and can be omitted. The annealed hot rolled sheet may be pickled.

Next, the hot rolled sheet is cold-rolled to prepare the cold rolled sheet. The cold rolling is finally performed at a thickness of 0.1 mm to 0.3 mm. If necessary, the cold rolling may include once cold rolling or twice or more cold rolling with intermediate annealing therebetween. At this time, the intermediate annealing temperature may be 850 to 1150° C.

Next, the cold rolled sheet is finally annealed. In the process of annealing the cold rolled sheet, the annealing temperature is not greatly limited so long as the temperature is a temperature to be generally applied to the non-oriented electrical steel sheet. Since the iron loss of the non-oriented electrical steel sheet is closely associated with a grain size, the annealing temperature is suitable for 900 to 1100° C. In the final annealing process, the average grain diameter may be 40 to 100 μm, and all of the processing tissues formed in the cold rolling step as the previous step, are all (i.e., 99% or more) recrystallized.

After final annealing, an insulating film may be formed. The insulating film may be treated with organic, inorganic, and organic/inorganic composite films, and may be treated with other coating agents capable of insulation.

Hereinafter, the present invention will be described in more detail through Examples. However, these Examples are only for illustrative of the present invention, and the present invention is not limited thereto.

### Example

A slab was manufactured by ingredients shown in Table 1. The slab was heated at 1150° C. and hot-rolled at a finishing temperature of 780° C. to manufacture a hot rolling sheet having a plate thickness of 2.0 mm. The hot rolling sheet which was hot rolled was annealed at 1030° C. for 100 seconds and then pickled and cold-rolled to have thicknesses of 0.15, 0.25, 0.27, and 0.30 mm, and recrystallization annealed at 1000° C. for 100 seconds.

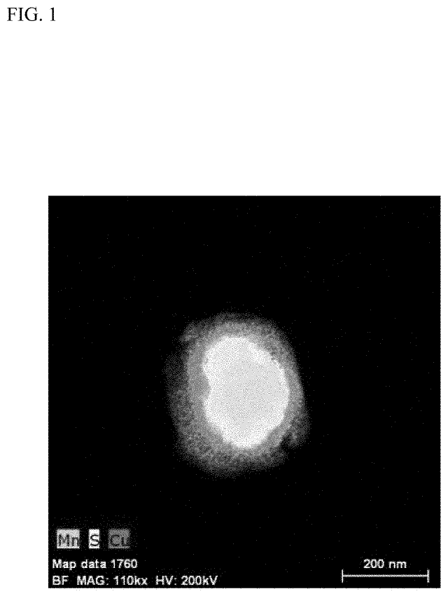

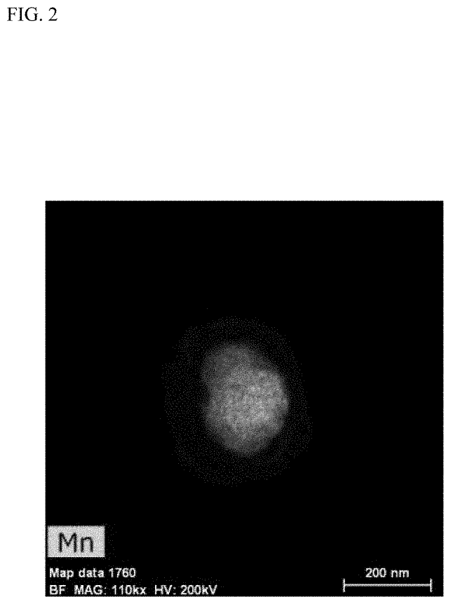

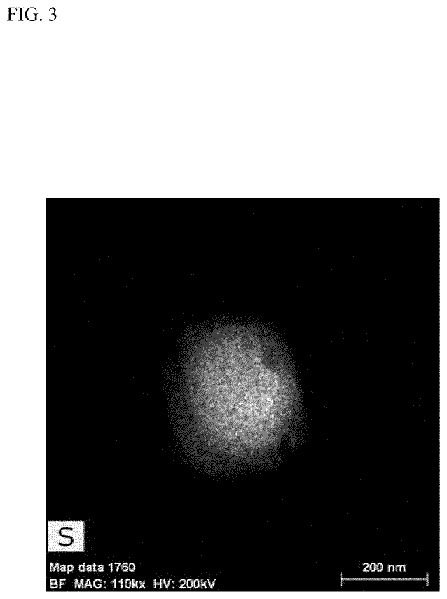

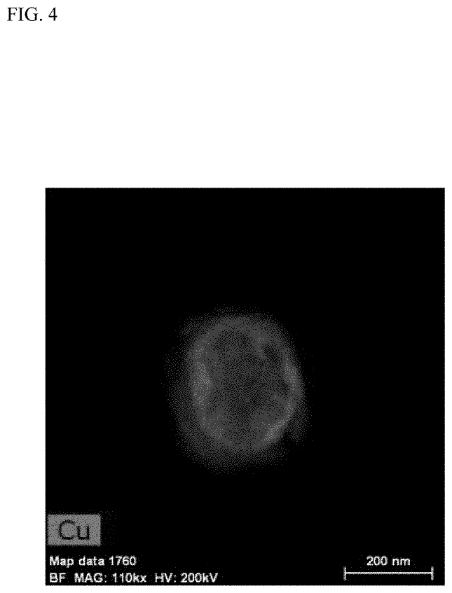

A thickness for each specimen, [Mn]/[Cu], [Cu]/[S], a 20 to 100 nm-diameter sulfide distribution density (a), a 150 to 300 nm-diameter sulfide distribution density (b), b/a, a fraction of a sulfide including both Mn and Cu among the sulfides, W_{15/50}, W_{10/400}, and B₅₀ are shown in Table 2. The 20 to 100 nm-diameter and 150 to 300 nm-diameter sulfide distribution densities are shown by measuring diameters of precipitates in which S is detected as a result of EDS analysis of precipitates discovered when an area of 0.5 μm² or more by observing 5 μm×5 μm×20000 sheets or more by Tem for the same specimen. The fraction of the sulfide including both Mn and Cu among the sulfides means a fraction of sulfides in which Mn and Cu are simultaneously detected among all sulfides including S discovered in the TEM EDS observation. FIGS. 1 to 4 illustrate photographs of an electron microscope of a sulfide in which both Mn and Cu are detected. In respect to the magnetic characteristics such as the magnetic flux density, the iron loss, etc., an average value is shown by cutting 60 mm wide×60 mm long×5-sheet specimens, and measuring the magnetic characteristics in a rolling direction and a rolling vertical direction by a single sheet tester for each specimen. In this case, W_{15/50} is iron loss when a magnetic flux density of 1.5 T is organized at a frequency of 50 Hz, W_{10/400} is iron loss when a magnetic flux density of 1.0 T is organized at a frequency of 400 Hz, and B50 means a magnetic flux density induced from a magnetic field of 5000 A/m.

TABLE 1

| Specimen | | | | | | | | | | |
|---|---|---|---|---|---|---|---|---|---|---|
| No. | Si(%) | Al(%) | Mn(%) | Cu(%) | C(ppm) | S(ppm) | N(ppm) | Nb(ppm) | Ti(ppm) | V(ppm) |
| A1 | 3 | 1.8 | 1.3 | 0.002 | 26 | 4 | 22 | 19 | 31 | 30 |
| A2 | 3 | 1.8 | 1.3 | 0.03 | 28 | 44 | 11 | 22 | 30 | 29 |
| A3 | 3 | 1.8 | 1.3 | 0.008 | 31 | 26 | 11 | 27 | 10 | 28 |
| A4 | 3 | 1.8 | 1.3 | 0.006 | 25 | 9 | 21 | 32 | 8 | 21 |
| B1 | 3.6 | 1 | 1.7 | 0.014 | 21 | 22 | 18 | 31 | 25 | 17 |
| B2 | 3.6 | 1 | 1.7 | 0.006 | 21 | 16 | 8 | 25 | 11 | 9 |
| B3 | 3.6 | 1 | 1.7 | 0.01 | 37 | 32 | 28 | 31 | 14 | 21 |
| B4 | 3.6 | 1 | 1.7 | 0.009 | 43 | 16 | 18 | 27 | 10 | 18 |
| C1 | 3.8 | 1 | 1.4 | 0.008 | 21 | 40 | 11 | 28 | 21 | 32 |
| C2 | 3.8 | 1 | 1.4 | 0.006 | 28 | 8 | 16 | 30 | 28 | 31 |
| C3 | 3.8 | 1 | 1.4 | 0.008 | 30 | 14 | 21 | 31 | 29 | 10 |
| C4 | 3.8 | 1 | 1.4 | 0.007 | 36 | 13 | 18 | 38 | 22 | 9 |
| D1 | 3.2 | 1.4 | 0.8 | 0.005 | 28 | 13 | 16 | 26 | 19 | 21 |
| D2 | 3.2 | 1.4 | 2.2 | 0.013 | 29 | 20 | 21 | 14 | 18 | 14 |
| D3 | 3.2 | 1.4 | 1.8 | 0.009 | 23 | 27 | 31 | 27 | 28 | 14 |
| D4 | 3.2 | 1.4 | 1.8 | 0.011 | 20 | 33 | 27 | 32 | 26 | 26 |
| E1 | 3.4 | 1.3 | 1.5 | 0.009 | 28 | 64 | 22 | 31 | 43 | 28 |
| E2 | 3.4 | 1.3 | 1.5 | 0.007 | 39 | 71 | 19 | 18 | 14 | 21 |
| E3 | 3.4 | 1.3 | 1.5 | 0.008 | 30 | 22 | 18 | 12 | 15 | 18 |
| E4 | 3.4 | 1.3 | 1.5 | 0.009 | 29 | 26 | 19 | 17 | 17 | 26 |

TABLE 2

| | | | | | | | Fraction of | | | | |
|---|---|---|---|---|---|---|---|---|---|---|---|
| | | | | | | | sulfides containing | | | | |
| | | | | 20 to 100-nm | 150 to 300-nm | | both Mn and Cu | | | | |
| | | | | sulfide | sulfide | | among sulfides | | | | |
| | | | | distribution | distribution | | having diameter | | | | |
| Specimen | Thickness | | | density (a) | density (b) | | of 150 to 300 nm | W15/50 | W10/400 | B50 | |
| No. | (mm) | [Mn]/[Cu] | [Cu]/[S] | (sulfides/mm2) | (sulfides/mm2) | b/a | (%) | (W/kg) | (W/kg) | (T) | Remarks |
| A1 | 0.15 | 650 | 5 | 45 | 13 | 0.29 | 37 | 1.93 | 9.9 | 1.62 | Comparative |
| | | | | | | | | | | | Example |
| A2 | | 43.3 | 6.82 | 92 | 83 | 0.9 | 51 | 1.95 | 9.8 | 1.62 | Comparative |
| | | | | | | | | | | | Example |
| A3 | | 162.5 | 3.08 | 31 | 77 | 2.48 | 76 | 1.68 | 8.7 | 1.65 | Inventive |
| | | | | | | | | | | | Example |
| A4 | | 216.7 | 6.67 | 23 | 54 | 2.35 | 77 | 1.68 | 8.6 | 1.65 | Inventive |
| | | | | | | | | | | | Example |
| B1 | 0.25 | 121.4 | 6.36 | 41 | 63 | 1.54 | 42 | 2.01 | 12.5 | 1.63 | Comparative |
| | | | | | | | | | | | Example |
| B2 | | 283.3 | 3.75 | 44 | 61 | 1.39 | 39 | 2 | 12.3 | 1.63 | Comparative |
| | | | | | | | | | | | Example |
| B3 | | 170 | 3.13 | 37 | 96 | 2.59 | 81 | 1.79 | 10.8 | 1.67 | Inventive |
| | | | | | | | | | | | Example |
| B4 | | 188.9 | 5.63 | 29 | 87 | 3 | 76 | 1.78 | 11 | 1.67 | Inventive |
| | | | | | | | | | | | Example |
| C1 | | 175 | 2 | 72 | 81 | 1.13 | 31 | 2.02 | 12.4 | 1.63 | Comparative |
| | | | | | | | | | | | Example |
| C2 | | 233.3 | 7.5 | 36 | 41 | 1.14 | 49 | 2.02 | 12.3 | 1.63 | Comparative |
| | | | | | | | | | | | Example |
| C3 | | 175 | 5.71 | 27 | 67 | 2.48 | 83 | 1.77 | 10.8 | 1.67 | Inventive |
| | | | | | | | | | | | Example |
| C4 | | 200 | 5.38 | 22 | 63 | 2.86 | 74 | 1.79 | 10.9 | 1.67 | Inventive |
| | | | | | | | | | | | Example |
| D1 | 0.27 | 160 | 3.85 | 51 | 55 | 1.08 | 33 | 2.04 | 13.4 | 1.63 | Comparative |
| | | | | | | | | | | | Example |
| D2 | | 169.2 | 6.5 | 45 | 61 | 1.36 | 56 | 2.05 | 13.3 | 1.63 | Comparative |
| | | | | | | | | | | | Example |
| D3 | | 200 | 3.33 | 36 | 89 | 2.47 | 77 | 1.8 | 11.8 | 1.67 | Inventive |
| | | | | | | | | | | | Example |
| D4 | | 163.6 | 3.33 | 28 | 78 | 2.79 | 74 | 1.78 | 11.7 | 1.67 | Inventive |
| | | | | | | | | | | | Example |
| E1 | 0.3 | 166.7 | 1.41 | 73 | 52 | 0.71 | 51 | 2.06 | 14.3 | 1.64 | Comparative |
| | | | | | | | | | | | Example |
| E2 | | 214.3 | 0.99 | 81 | 59 | 0.73 | 47 | 2.05 | 14.4 | 1.64 | Comparative |
| | | | | | | | | | | | Example |
| E3 | | 187.5 | 3.64 | 32 | 79 | 2.47 | 73 | 1.82 | 12.7 | 1.68 | Inventive |
| | | | | | | | | | | | Example |
| E4 | | 166.7 | 3.46 | 28 | 81 | 2.89 | 75 | 1.84 | 12.6 | 1.68 | Inventive |
| | | | | | | | | | | | Example |

As shown in Tables 1 and 2, A3, A4, B3, B4, C3, C4, D3, D4, E3, and E4 in which alloy ingredients are appropriately controlled have an appropriate value of a ratio of the sulfides having the diameter of 20 to 100 nm and the sulfides having the diameter of 150 to 300 nm, the magnetic characteristics of all of A3, A4, B3, B4, C3, C4, D3, D4, E3, and E4 are shown to be excellent.

On the contrary, since a Cu content in A1 or A2 was low or exceeded, sulfides having a fine size harmful to magnetic properties increased and formation of sulfides having a coarse size was suppressed, and as a result, the iron loss was poor and the magnetic flux density was lowered. Since each of a content ratio of Mn and Cu in B1 or B2 and a content ratio of Cu and S in Cl or C2 was exceeded, sulfides having a size harmful to the magnetic properties increased and formation of coarse composite sulfides was suppressed, and as a result, the iron loss and the magnetic flux density were lowered. Since a Mn content in D1 or D2 was low or exceeded, the iron loss and the magnetic flux density were shown to be lowered. Since a S content in E1 or E2 was exceeded, sulfides having a fine size harmful to the magnetic properties rapidly increased, and as a result, the iron loss and the magnetic flux density were lowered.

The present invention is not limited to the exemplary embodiments and can be manufactured in various different forms, and it will be appreciated that those skilled in the art to which the present invention pertains can be executed in other detailed forms without changing the technical spirit or requisite features of the present invention. Therefore, it should be appreciated that the aforementioned embodiments are illustrative in all aspects and are not restricted.

1. A non-oriented electrical steel sheet comprising, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfies formulas 1 and 2 below.
150≤[Mn]/[Cu]≤250 [Formula 1]
3≤[Cu]/[S]≤7 [Formula 2]
(here, [Mn], [Cu], and [S] represent Mn, Cu, and S contents (weight %), respectively.)

2. The non-oriented electrical steel sheet of claim 1, further comprising:
at most 0.005 weight % of each of at least one of C and N.

3. The non-oriented electrical steel sheet of claim 1, further comprising:
at most 0.004 weight % of each of at least one of Nb, Ti, and V.

4. The non-oriented electrical steel sheet of claim 1, further comprising:
at least one of at most 0.02% of P, at most 0.002% of B, at most 0.005% of Mg, and at most 0.005% of Zr.

5. The non-oriented electrical steel sheet of claim 1, wherein
the number of sulfides having a diameter of 150 to 300 nm is twice or more larger than the number of sulfides having a diameter of 20 to 100 nm.

6. The non-oriented electrical steel sheet of claim 1, comprising:
sulfides having the diameter of 150 to 300 nm,
wherein an area fraction of sulfides containing both Mn and Cu among the sulfides having the diameter of 150 to 300 nm is 70% or more.

7. The non-oriented electrical steel sheet of claim 1, wherein
a thickness of a steel sheet is 0.1 to 0.3 mm.

8. The non-oriented electrical steel sheet of claim 1, wherein
an average grain diameter is 40 to 100 μm.

9. A method for manufacturing a non-oriented electrical steel sheet which comprises, by weight %, 1.5 to 4.0% of Si, 0.7 to 2.5% of Al, 1 to 2% of Mn, 0.003 to 0.02% of Cu, at most 0.005% of S (not 0%), and the remainder comprising Fe and unavoidable impurities, and satisfies formulas 1 and 2 below, comprising: heating a slab satisfying formulas 1 and 2 below;
preparing a hot rolling sheet by hot-rolling the slab;
preparing a cold rolling sheet by cold-rolling the hot rolling sheet; and
finally annealing the cold rolling sheet.
150≤[Mn]/[Cu]≤250 [Formula 1]
3≤[Cu]/[S]≤7 [Formula 2]
(here, [Mn], [Cu], and [S] represent Mn, Cu, and S contents (weight %), respectively.)

10. The method for manufacturing a non-oriented electrical steel sheet of claim 9, wherein
in the heating of the slab, the slab is heated at a temperature of 1200° C. or less.

11. The method for manufacturing a non-oriented electrical steel sheet of claim 9, wherein
in the hot rolling, a finishing rolling temperature is 750° C. or more.

12. The method for manufacturing a non-oriented electrical steel sheet of claim 9, further comprising:
after the hot rolling, annealing the hot rolling sheet in the range of 850 to 1150° C.

13. The method for manufacturing a non-oriented electrical steel sheet of claim 9, wherein
the cold rolling includes one cold rolling or two or more cold rolling with intermediate annealing interposed therebetween.

14. The method for manufacturing a non-oriented electrical steel sheet of claim 13, wherein
the intermediate annealing temperature is 850 to 1150° C.
